(19) United States
(12) Patent Application Publication
(10) Pub. No.: US 2025/0061884 A1
(43) Pub. Date: Feb. 20, 2025

(54) SPEECH RECOGNIZING SYSTEM, AND SPEECH RECOGNIZING METHOD

(71) Applicant: NEC Corporation, Minato-ku, Tokyo (JP)

(72) Inventors: Ling GUO, Tokyo (JP); Hitoshi YAMAMOTO, Tokyo (JP)

(73) Assignee: NEC Corporation, Minato-ku, Tokyo (JP)

(21) Appl. No.: 18/724,673

(22) PCT Filed: Mar. 1, 2022
(86) PCT No.: PCT/JP2022/008597

§ 371 Date: Jun. 27, 2024

(51) Int. Cl. G10L 13/02

(52) U.S. Cl. CPC G10L 13/02

(57) ABSTRACT

A speech recognizing system comprises: an utterance data acquiring means for acquiring real utterance data uttered by a speaker, a text converting means for converting the real utterance data into a text data, a speech synthesizing means for generating corresponding synthesis speech corresponding to the real utterance data by speech synthesizing using the text data, a conversion model generating means for generating a conversion model converting input speech into synthesis speech using the real utterance data and the corresponding synthesis speech, and a speech recognizing means for speech recognizing the synthesis speech converted using the conversion model.

### TECHNICAL FIELD

This disclosure relates to technical field of a speech recognizing system, a speech recognizing method and a recording medium.

### BACKGROUND

It is known that a system generates synthesis speech as this kind of system. For example, Patent Literature 1 discloses generating synthesis speech such as converting feature value indicting a voice quality of speech by a learned conversion model. Patent Literature 2 discloses generating a sentence of a target language from obtained text data as speech recognizing result, and generating synthesis speech from the sentence of the target language.

For example, Patent Literature 3, as other relating technique, discloses performing learning a speech conversion model by learning corpus.

### CITATION LIST

### Patent Literature

Patent Literature 1: International Publication No. 2021/033685

Patent Literature 2: International Publication No. 2014/010450

Patent Literature 3: Japanese Patent Application Laid Open No. 2020-166224

### SUMMARY

### Technical Problem

This disclosure aims to improve techniques disclosed in the prior art literature.

### Solution to Problem

One aspect of a speech recognizing system of this disclosure comprises: an utterance data acquiring means for acquiring real utterance data uttered by a speaker, a text converting means for converting the real utterance data into a text data, a speech synthesizing means for generating corresponding synthesis speech corresponding to the real utterance data by speech synthesizing using the text data, a conversion model generating means for generating a conversion model converting input speech into synthesis speech using the real utterance data and the corresponding synthesis speech, and a speech recognizing means for speech recognizing the synthesis speech converted using the conversion model.

One aspect of a speech recognizing system of this disclosure comprises: a sign language data acquiring means for acquiring sign language data, a text converting means for converting the sign language data into text data, a speech synthesizing means for generating corresponding synthesis speech corresponding to the sign language data by speech synthesizing using the text data, a conversion model generating means for generating a conversion model converting input sign language into synthesis speech using the sign language data and the corresponding synthesis speech, and a speech recognizing means for speech recognizing the synthesis speech converted using the conversion model.

One aspect of a speech recognizing method of this disclosure, by at least one computer, acquires real utterance data uttered by a speaker, converts the real utterance data into a text data, generates corresponding synthesis speech corresponding to the real utterance data by speech synthesizing using the text data, generates a conversion model converting input speech into synthesis speech using the real utterance data and the corresponding synthesis speech, and speech recognizes the synthesis speech converted using the conversion model.

One aspect of a recording medium of this disclosure records a computer program, wherein the computer program making at least one computer perform a speech recognizing method acquiring real utterance data uttered by a speaker, converting the real utterance data into a text data, generating corresponding synthesis speech corresponding to the real utterance data by speech synthesizing using the text data, generating a conversion model converting input speech into synthesis speech using the real utterance data and the corresponding synthesis speech and speech recognizing the synthesis speech converted using the conversion model.

### BRIEF DESCRIPTION OF DRAWINGS

FIG. 1 is a block diagram showing a hardware configuration of a speech recognizing system of a first embodiment.

FIG. 2 is a block diagram showing a functional configuration of the speech recognizing system of the first embodiment.

FIG. 3 is a flowchart showing flow of conversion model generating operation by the speech recognizing system of the first embodiment.

FIG. 4 is a flowchart showing flow of speech recognizing operation by the speech recognizing system of the first embodiment.

FIG. 5 is a functional configuration of a speech recognizing system of a second embodiment.

FIG. 6 is a flowchart showing flow of conversion model learning operation by the speech recognizing system of the second embodiment.

FIG. 7 is a block diagram showing a functional configuration of a speech recognizing system of a third embodiment.

FIG. 8 is a flowchart showing flow of speech recognition model generating operation by the speech recognizing system of the third embodiment.

FIG. 9 is a block diagram showing a functional configuration of a speech recognizing system of a fourth embodiment.

FIG. 10 is a flowchart showing flow of speech recognition model learning operation by the speech recognizing system of the fourth embodiment.

FIG. 11 is a block diagram showing a functional configuration of a speech recognizing system of a fifth embodiment.

FIG. 12 is a flowchart showing flow of conversion model generating operation by the speech recognizing system of the fifth embodiment.

FIG. 13 is a block diagram showing a functional configuration of a speech recognizing system of a sixth embodiment.

FIG. 14 is a flowchart showing flow of conversion model generating operation by the speech recognizing system of the sixth embodiment.

FIG. 15 is a block diagram showing a functional configuration of a speech recognizing system of a seventh embodiment.

FIG. 16 is a flowchart showing flow of conversion model generating operation by the speech recognizing system of the seventh embodiment.

FIG. 17 is a block diagram showing a functional configuration of a speech recognizing system of a modification of the seventh embodiment.

FIG. 18 is a flowchart showing flow of conversion model generating operation by the speech recognizing system of the modification of the seventh embodiment.

FIG. 19 is a block diagram showing a functional configuration of a speech recognizing system of an eighth embodiment.

FIG. 20 is a flowchart showing flow of conversion model generating operation by the speech recognizing system of the eighth embodiment.

FIG. 21 is a flowchart showing flow speech recognizing operation by the speech recognizing system of the eighth embodiment.

### DESCRIPTION OF EMBODIMENTS

Embodiments of a speech recognizing system, a speech recognizing method and a recording medium are described hereinafter with referring figures.

### First Embodiment

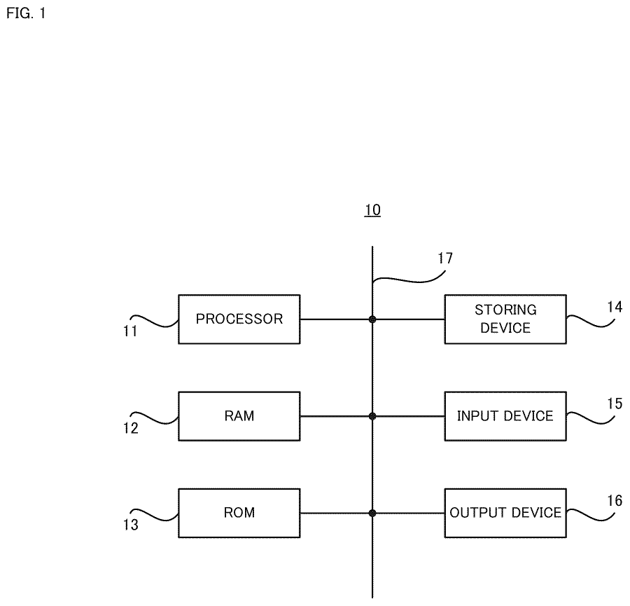

A speech recognizing system of a first embodiment is described with referring to FIG. 1 to FIG. 4.

### (Hardware Configuration)

First, a hardware configuration of the speech recognizing system of the first embodiment is described with referring to FIG. 1. FIG. 1 is a block diagram showing the hardware configuration of the speech recognizing system of the first embodiment.

As shown in FIG. 1, the speech recognizing system 10 of the first embodiment comprises a processor 11, a RAM (Random Access Memory) 12, a ROM (Read Only Memory) 13, and a storing device 14. The speech recognizing system 10 may further comprise an input device 15 and an output device 16. The processor 11, the RAM 12, the ROM 13, the storing device 14, the input device 15 and the output device 16 described above are connected through a data bus 17.

The processor 11 reads computer programs. For example, the processor 11 is configured to read a computer program stored in at least one of the RAM 12, the ROM 13 and the storing device 14. Alternatively, the processor 11 may read a computer program stored in a computer readable recording medium using a recording medium reading apparatus which is not shown. The processor 11 may acquire (i.e., read) a computer program from a not shown apparatus, which is located at outside of the speech recognizing system 10 through a network interface. The processor 11 controls the RAM 12, the storing device 14, the input device 15 and the output device 16 by performing read computer programs. In this embodiment, especially, function blocks for performing speech recognition are realized in the processor 11 when the processor 11 performs read computer programs. Thus, the processor 11 may function as a controller for performing each control in the speech recognizing system 10.

The processor 11 may be configured as a CPU (Central Processing Unit), a GPU (Graphics Processing Unit), an FPGA (Field-Programmable Gate Array), a DSP (Demand-Side Platform), and/or an ASIC (Application Specific Integrated Circuit), for example. The processor 11 may be configured by one of these, or may be configured by using plural in parallel.

The RAM 12 temporarily stores computer programs which are performed by the processor 11. The RAM 12 temporarily stores data which are temporarily used by the processor 11 when the processor performs computer programs. The RAM 12 may be D-RAM (Dynamic Random Access Memory) or SRAM (Static Random Access Memory), for example. Moreover, other types of non-volatile memories may be used instead of the RAM 12.

The ROM 13 stores computer programs performed by the processor 11. The ROM 13 additionally may store fixed data. The ROM 13 may be a P-ROM (Programmable Read Only Memory) or EPROM (Erasable Programmable Read Only Memory), for example. Moreover, other types of non-volatile memories may be used instead of the ROM 13.

The storing device 14 stores data which is preserved for a long time by the speech recognizing system 10. The storing device 14 may function as a temporary storing device of the processor 11. The storing device 14 may include at least one of a hard disk device, an optical magnetic disk device, an SSD (Solid State Drive) and a disk array device, for example.

The input device 15 is a device receiving input instructions from a user of the speech recognizing system 10. The input device 15 may include at least one of a keyboard, a mouse and a tach panel, for example. The input device 15 may be configured as a mobile terminal such as a smartphone or a tablet. The input device 15 may be a device which includes a microphone, and which can speech input.

The output device 16 is a device outputting information about the speech recognizing system 10 to an outside. For example, the output device 16 may be a display device (e.g., a display) which can display information about the speech recognizing system 10. Moreover, the output device 16 may be such as a speaker which can output voice indicating information about the speech recognizing system 10. The output device 16 may be configured as a mobile terminal such as a smartphone or a tablet. Moreover, the output device 16 may be a device outputting information in a format other than image. The output device 16 may be a speaker outputting voice indicating information about the speech recognizing system 10.

In FIG. 1, the speech recognizing system 10, which is configured to include a plurality of devices, is shown as an example, however, all or a part of these functions may be realized as a single apparatus (i.e., a speech recognizing apparatus). In this case, for example, the speech recognizing apparatus may be configured to comprise only the processor 11, the RAM 12 and the ROM 13 described above, and an outside device, which is connected to the speech recognizing apparatus, may comprise other components (i.e., the storing device 14, the input device 15 and the output device 16). Moreover, the speech recognizing apparatus may be an apparatus, in which a part of arithmetic functions is realized by an outside apparatus (such as an outside server or a cloud).

### (Functional Configuration)

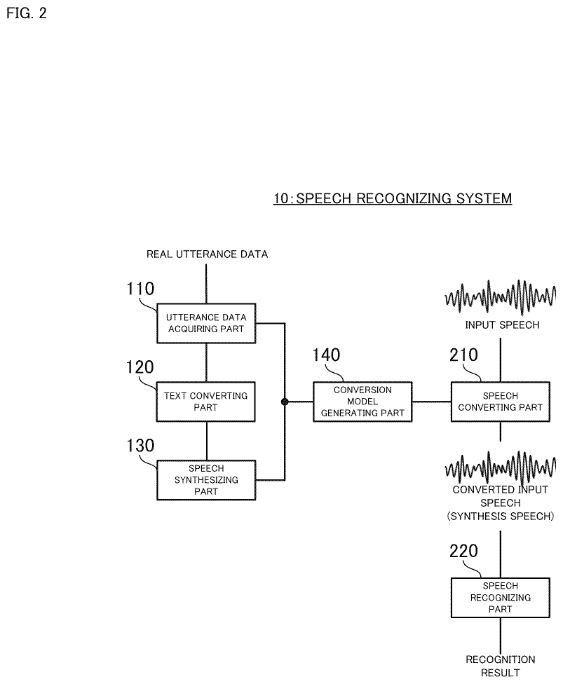

Next, a functional configuration of the speech recognizing system 10 of the first embodiment is described with referring to FIG. 2. FIG. 2 is a block diagram showing the functional configuration of the speech recognizing system of the first embodiment.

As shown in FIG. 2, the speech recognizing system 10 of the first embodiment, for realizing its functions, is configured to comprise an utterance data acquiring part 110, a text converting part 120, a speech synthesizing part 130, a conversion model generating part 140, a speech converting part 210 and a speech recognizing part 220. Each of the utterances data acquiring part 110, the text converting part 120, the speech synthesizing part 130, the conversion model generating part 140, the speech converting part 210 and the speech recognizing part 220 may be a processing block realized by the above-mentioned processor 11 (see FIG. 1), for example.

The utterance data acquiring part 110 is configured to be able to acquire real utterance data uttered by a speaker. The real utterance data may be voice data (e.g., waveform data). The real utterance data may be acquired from a database (i.e., real utterance voice corpus) which accumulates a plurality of real utterances data, for example. It is configured that the real utterance data acquired by the utterance data acquiring part 110 is outputted to the text converting part 120 and the conversion model generating part 140.

The text converting part 120 is configured to be able to convert the real utterance data acquired by the utterance data acquiring part 110 into text data. In other words, the text converting part 120 is configured to be able to perform a process for text converting voice data. Wherein, existing techniques may be suitably used as specific techniques of text converting. It is configured that the text data (i.e., text data corresponding to real utterance data) converted by the text converting part 120 is outputted to the speech synthesizing part 130.

The speech synthesizing part 130 is configured to be able to generate corresponding synthesis speech corresponding to real utterance data by speech synthesizing the text data converted by the text converting part 120. Wherein, existing techniques may be suitably used as specific techniques of speech synthesizing. It is configured that the corresponding synthesis speech generated by the speech synthesizing part 130 is outputted to the conversion model generating part 140. Alternatively, the corresponding synthesis speech may be accumulated in a database which can accumulate a plurality of corresponding synthesis speech (i.e., synthesis speech corpus), and then the corresponding synthesis speech may be outputted to the conversion model generating part 140.

The conversion model generating part 140 is configured to be able to generate a conversion model which converts input speech into synthesis speech using the real utterance data acquired by the utterance data acquiring part 110 and the corresponding synthesis speech synthesized by the speech synthesizing part 130. The conversion model converts input speech uttered a speaker (i.e., human voice) such that the input speech closes to synthesis speech (i.e., mechanical voice). The conversion model generating part 140 may be configured to generate a conversion model using a GAN (Generative Adversarial Network), for example. It is configured that the conversion model generated by the conversion model generating part 140 is outputted to the speech converting part 210.

The speech converting part 210 is configured to be able to convert input speech into synthesis speech using the conversion model generated by the conversion model generating part 140. The input speech inputted to the speech converting part 210 may be speech inputted using such as a microphone. It is configurated that the synthesis speech converted by the speech converting part 210 is outputted to the speech recognizing part 220.

The speech recognizing part 220 is configured to be able to speech recognize the synthesis speech converted by the speech converting part 210. In other words, the speech recognizing part 220 is configured to be able to perform a process for converting the synthesis speech into text. The speech recognizing part 220 may be configured to be able to output a speech recognition result of the synthesis speech. Wherein, there are no particular limitations on how to use the speech recognition result.

### (Conversion Model Generating Operation)

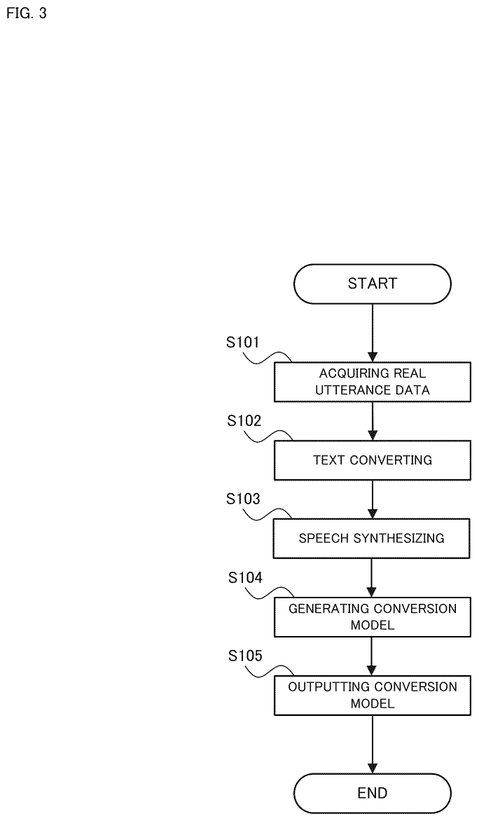

Next, flow of an operation generating a conversion model (hereinafter, referring to as a “conversion model generating operation” as appropriate) by the speech recognizing system 10 of the first embodiment is described with referring to FIG. 3. FIG. 3 is a flowchart showing flow of the conversion model generating operation by the speech recognizing system 10 of the first embodiment.

As shown in FIG. 3, when the conversion model generating operation is started by the speech recognizing system 10 of the first embodiment, first, the utterance data acquiring part 110 acquires real utterance data (step S101). Then, the text converting part 120 converts the real utterance data acquired by the utterance data acquiring part 110 into text data (step S102).

Next, the speech synthesizing part 130 generates corresponding synthesis speech corresponding to the real utterance data by speech synthesizing the text data converted by the text converting part 120 (step S103). Then, the conversion model generating part 140 generates a conversion model on the basis of the real utterance data acquired by the utterance data acquiring part 110 and the corresponding synthesis speech generated by the speech synthesizing part 130 (step S104). After that, the conversion model generating part 140 outputs the generated conversion model to the speech converting part 210 (step S105).

### (Speech Recognizing Operation)

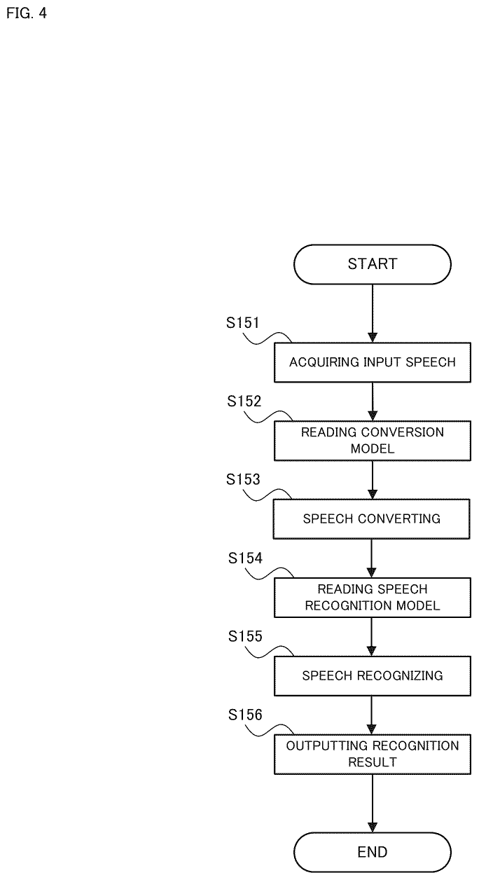

Next, flow of an operation performing speech recognition (hereinafter, referring to as a “speech recognizing operation” as appropriate) by the speech recognizing system 10 of the first embodiment is described with referring to FIG. 4. FIG. 4 is a flowchart showing the flow of the speech recognizing operation by the speech recognizing system of the first embodiment.

As shown in FIG. 4, when the speech recognizing operation is started by the speech recognizing system 10 of the first embodiment, first the speech converting part 210 acquires input speech (step S151). Then, the speech converting part 210 reads the conversion model generated by the conversion model generating part 140 (step S152). After that, the speech converting part 210 performs speech conversion using the read conversion model, and converts the input speech into synthesis speech (step S153).

Next, the speech recognizing part 220 reads a speech recognition model (i.e., a model for performing speech recognition) (step S154). Then, the speech recognizing part 220 speech recognizes the synthesis speech synthesized by the speech converting part 210 using the read speech recognition model (step S155). After that, the speech recognizing part 220 outputs a speech recognition result (step S156).

### (Technical Effect)

Next, technical effect obtained by the speech recognizing system 10 of the first embodiment is described.

As described with FIG. 1 to FIG. 4, in the speech recognizing system 10 of the first embodiment, real utterance data and corresponding synthesis speech corresponding to the real utterance data are used when a conversion model is generated. Especially; the corresponding synthesis speech corresponding to the real utterance data is generated by converting the real utterance data into text data, and speech synthesizing the text data. In this way, it is not necessary to prepare both of real utterance data and synthesis speech corresponding to it (i.e., the corresponding synthesis speech can be generated by preparing only the real utterance data), so that it is possible to reduce cost for generating a conversion model. As a result, it is possible to realize speech recognition with low cost and high recognition accuracy.

### Second Embodiment

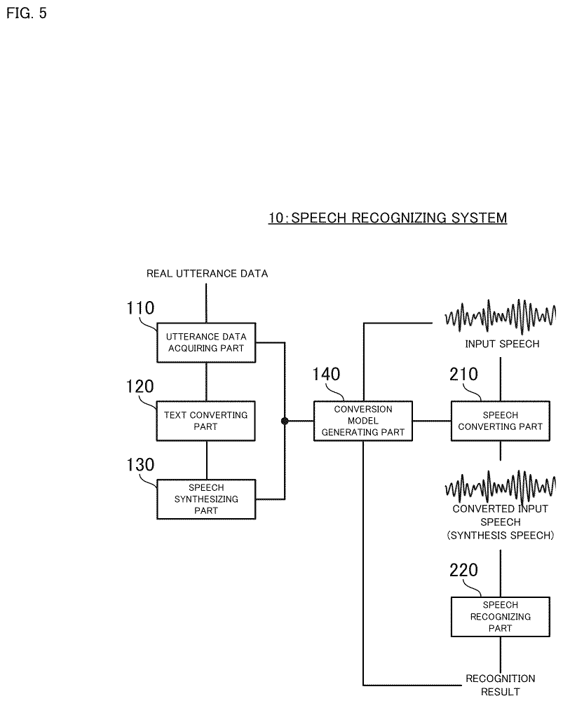

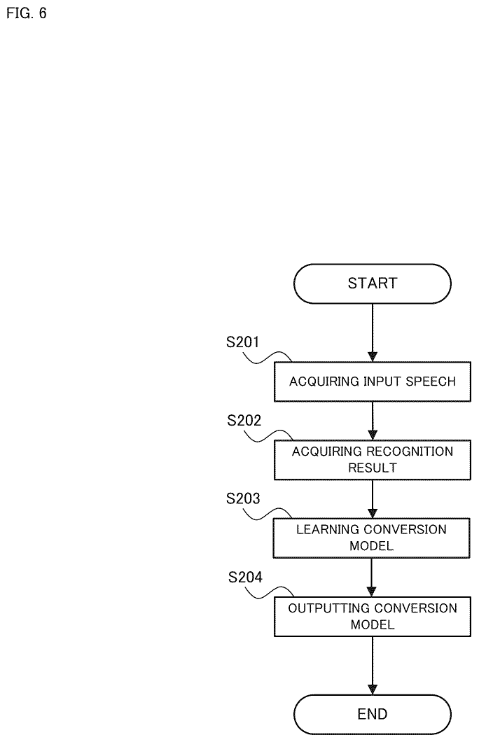

A speech recognizing system 10 of a second embodiment is described with referring to FIG. 5 and FIG. 6. Wherein, the second embodiment only differs a part of a configuration and a part of an operation from the above-mentioned first embodiment, and other parts may be the same as the first embodiment. Therefore, parts, that differ from the first embodiment already described, are following described in detail, and description about other repetition parts is omitted as appropriate.

### (Functional Configuration)

First, a functional configuration of the speech recognizing system 10 of the second embodiment is described with referring to FIG. 5. FIG. 5 is a block diagram showing the functional configuration of the speech recognizing system of the second embodiment. Wherein, in FIG. 5, a component, which is similar to the component shown in FIG. 2, is given the same symbol.

As shown in FIG. 5, the speech recognizing system 10 of the second embodiment is configured to comprise an utterance data acquiring part 110, a text converting part 120, a speech synthesizing part 130, a conversion model generating part 140, a speech converting part 210 and a speech recognizing part 220 as components for realizing its functions. In the second embodiment, especially, it is configured that input speech inputting in the speech converting part 210 and a recognition result by the speech recognizing part 220 are inputted in the conversion model generating part 140. The conversion model generating part 140 of the second embodiment is configured to be able to perform learning a conversion model on the basis of the input speech inputting to the speech converting part 210 and the recognition result by the speech recognizing part 220.

### (Conversion Model Learning Operation)

Next, flow of an operation learning a conversion model (hereinafter, referring to as a “conversion model learning operation” as appropriate) by the speech recognizing system 10 of the second embodiment is described with referring to FIG. 6. FIG. 6 is a flowchart showing the flow of the conversion model learning operation by the speech recognizing system of the second embodiment.

As shown in FIG. 6, when the conversion model learning operation is started by the speech recognizing system 10 of the second embodiment, first, the conversion model generating part 140 acquires input speech inputting to the speech converting part 210 (step S201). Then, the conversion model generating part 140 further acquires a speech recognition result when the input speech is inputted (i.e., the speech recognition result outputted in the step S156 shown in FIG. 4) (step S202).

Next, the conversion model generating part 140 learns a conversion model on the basis of the acquired input speech and speech recognition result (step S203). At this time, the conversion model generating part 140 may perform adjusting parameters of a conversion model already generated. After that, the conversion model generating part 140 outputs the learned conversion model to the speech converting part 210 (step S204).

### (Technical Effect)

Next, technical effect obtained by the speech recognizing system 10 of the second embodiment is described.

As described with FIG. 5 and FIG. 6, in the speech recognizing system 10 of the second embodiment, a conversion model is learned on the basis of input speech and a speech recognition result. In this way, since learn is performed by considering how the input speech is actually speech recognized, it is possible to learn a conversion model such that speech conversion is performed more suitable. Specifically, it is possible to learn a conversion model such that accuracy of the speech conversion using speech converted synthesis speech is improved.

### Third Embodiment

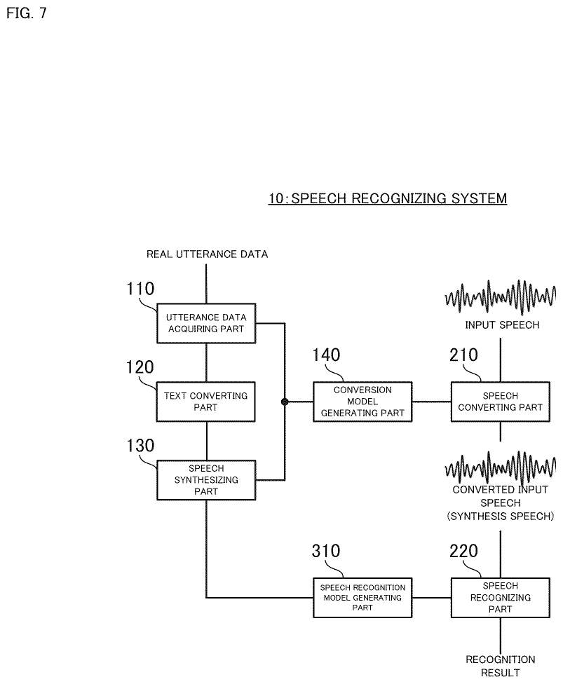

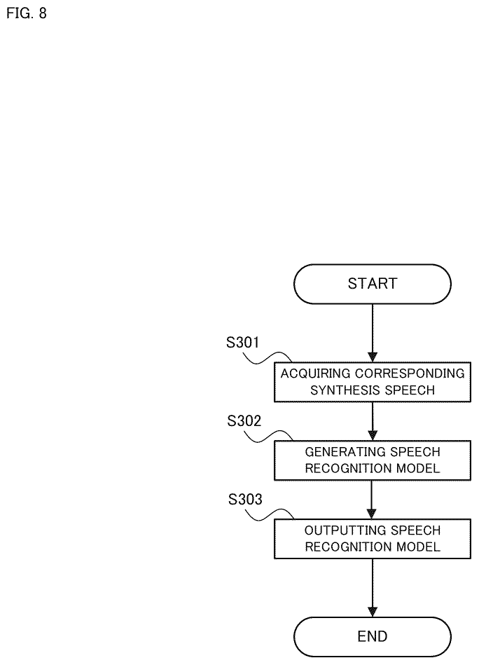

A speech recognizing system 10 of a third embodiment is described with referring to FIG. 7 and FIG. 8. Wherein, the third embodiment only differs a part of a configuration and a part of an operation from the above-mentioned first and second embodiments, and other parts may be the same as the first and second embodiments. Therefore, parts, that differ from each embodiment already described, are following described in detail, and description about other repetition parts is omitted as appropriate.

### (Functional Configuration)

First, a functional configuration of the speech recognizing system 10 of the third embodiment is described with referring to FIG. 7. FIG. 7 is a block diagram showing the functional configuration of the speech recognizing system of the third embodiment. Wherein, in FIG. 7, a component, which is similar to the component shown in FIG. 2, is given the same symbol.

As shown in FIG. 7, the speech recognizing system 10 of the third embodiment is configured to comprise an utterance data acquiring part 110, a text converting part 120, a speech synthesizing part 130, a conversion model generating part 140, a speech converting part 210, a speech recognizing part 220 and a speech recognition model generating part 310 as components for realizing its functions. In other words, the speech recognizing system 10 of the third embodiment further comprises the speech recognition model generating part 310 in addition to the configuration of the first embodiment (see FIG. 2). Wherein, the speech recognition model generating part 310 may be a process block realized by the above-mentioned processor 11 (see FIG. 1), for example.

The speech recognition model generating part 310 is configured to be able to generate a speech recognition model converting input speech into synthesis speech. Specifically, the speech recognition model generating part 310 is configured to be able to generate a speech recognition model using corresponding synthesis speech generated by a speech synthesizing means. Alternatively, the speech recognition model generating part 310 may generate a speech recognition model using the corresponding synthesis speech and other synthesis speech. The speech recognition model generating part 310 may be configured to directly acquire corresponding synthesis speech from the speech synthesizing part 130, or may be configured to acquire corresponding synthesis speech from synthesis speech corpus storing a plurality of corresponding synthesis speech generated the speech synthesizing means. It is configured that the speech recognition model generated by the speech recognition model generating part 310 is outputted to the speech recognizing part 220.

### (Speech Recognition Model Generating Operation)

Next, flow of an operation generating a speech recognition model (hereinafter, referring to as a “speech recognition model generating operation” as appropriate) by the speech recognizing system 10 of the third embodiment is described with referring to FIG. 8. FIG. 8 is a flowchart showing flow of the speech recognition model generating operation by the speech recognizing system of the third embodiment.

As shown in FIG. 8, when the speech recognition model generating operation is started by the speech recognizing system 10 of the third embodiment, first, the speech recognition model generating part 310 acquires the corresponding synthesis speech generated by the speech synthesizing part 130 (step S301).

Next, the speech recognition model generating part 310 generates a speech recognition model using the acquired corresponding synthesis speech (step S302). After that, the speech recognition model generating part 310 outputs the generated speech recognition model to the speech recognizing part 220 (step S303).

### (Technical Effect)

Next, technical effect obtained by the speech recognizing system 10 of the third embodiment is described.

As described with FIG. 7 and FIG. 8, in the speech recognizing system 10 of the third embodiment, a speech recognition model is generated using corresponding synthesis speech. In this way, since it is not necessary to separately prepare synthesis speech for generating a speech recognition model (in other words, it is possible to use corresponding synthesis speech used for generating a speech conversion model), it is possible to generate the speech recognition model effectively.

### Fourth Embodiment

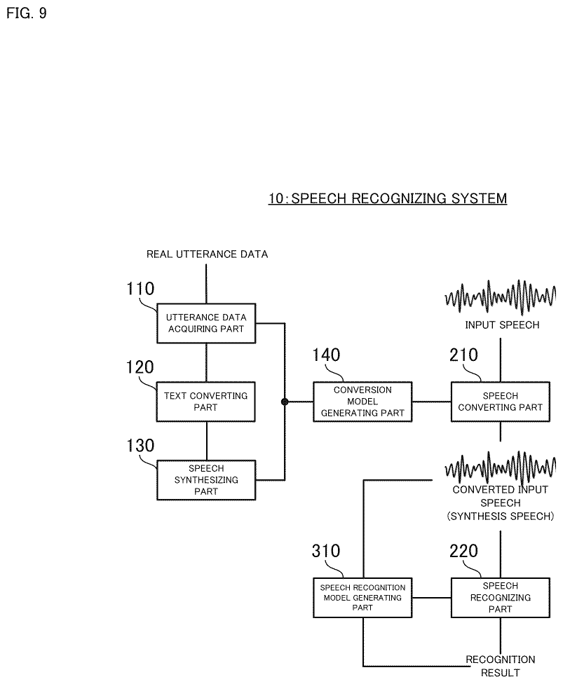

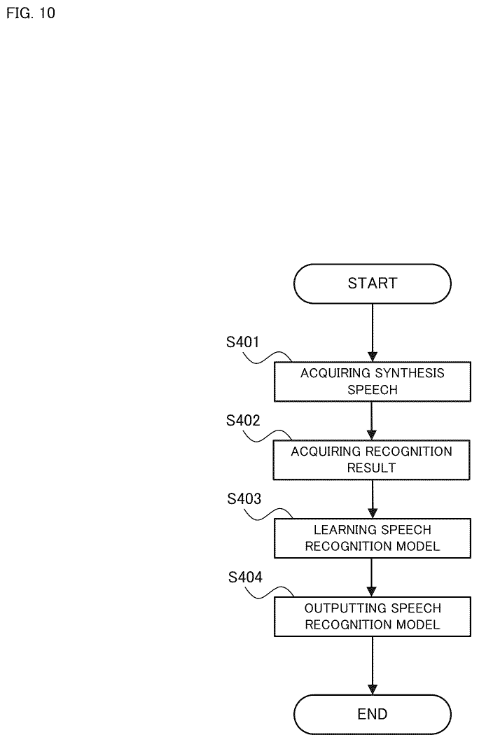

A speech recognizing system 10 of a fourth embodiment is described with referring to FIG. 9 and FIG. 10. Wherein, the fourth embodiment only differs a part of a configuration and a part of an operation from the above-mentioned first to third embodiments, and other parts may be the same as the first to third embodiments. Therefore, parts, that differ from each embodiment already described, are following described in detail, and description about other repetition parts is omitted as appropriate.

### (Functional Configuration)

First, a functional configuration of the speech recognizing system 10 of the fourth embodiment is described with referring to FIG. 9. FIG. 9 is a block diagram showing the functional configuration of the speech recognizing system of the fourth embodiment. Wherein, in FIG. 9, a component, which is similar to the component shown in FIG. 7, is given the same symbol.

As shown in FIG. 9, the speech recognizing system 10 of the fourth embodiment is configured to comprise an utterance data acquiring part 110, a text converting part 120, speech synthesizing part 130, a conversion model generating part 140, a speech converting part 210, a speech recognizing part 220 and a speech recognition model generating part 310 as components for realizing its functions. In the fourth embodiment, especially, it is configured that synthesis speech converted by the speech converting part 210 and recognition result by the speech recognizing part 220 are inputted to the speech recognition model generating part 310. The speech recognition model generating part 310 of the fourth embodiment is configured to be able to perform learning a speech recognition model on the basis of the synthesis speech converted by the speech converting part 210 and the recognition result by the speech recognizing part 220.

### (Speech Recognition Model Learning Operation)

Next, flow of an operation learning a speech recognition model (hereinafter, referring to as a “speech recognition model learning operation” as appropriate) by the speech recognizing system 10 of the fourth embodiment is described with referring to FIG. 10. FIG. 10 is a flowchart showing flow of the speech recognition model learning operation by the speech recognizing system of the fourth embodiment.

As shown in FIG. 10, when the speech recognition model learning operation is started by the speech recognizing system 10 of the fourth embodiment, first, the speech recognition model generating part 310 acquires the synthesis speech converted by the speech converting part 210 (in other words, the synthesis speech inputted in the speech recognizing part 220) (step S401). Then, the speech recognition model generating part 310 further acquires a speech recognition result of the synthesis speech (i.e., the speech recognition result outputted in the step S156 shown in FIG. 4) (step S402).

Next, the speech recognition model generating part 310 learns a speech recognition model on the basis of the acquired synthesis speech and speech recognition result (step S403). At this time, the speech recognition model generating part 310 may perform adjusting parameters of a speech recognition model already generated. After that, the speech recognition model generating part 310 outputs the learned speech recognition model to the speech converting part 210 (step S404).

### (Technical Effect)

Next, technical effect obtained by the speech recognizing system 10 of the fourth embodiment is described.

As described with FIG. 9 and FIG. 10, in the speech recognizing system 10 of the fourth embodiment, a speech recognition model is learned on the basis of synthesis speech and a speech recognition result. In this way, since learn is performed by considering how the synthesis speech is actually speech recognized, it is possible to learn a speech recognition model such that speech recognition is performed mora suitable. Specifically, it is possible to learn the speech recognition model such that accuracy of speech recognition is improved.

### Fifth Embodiment

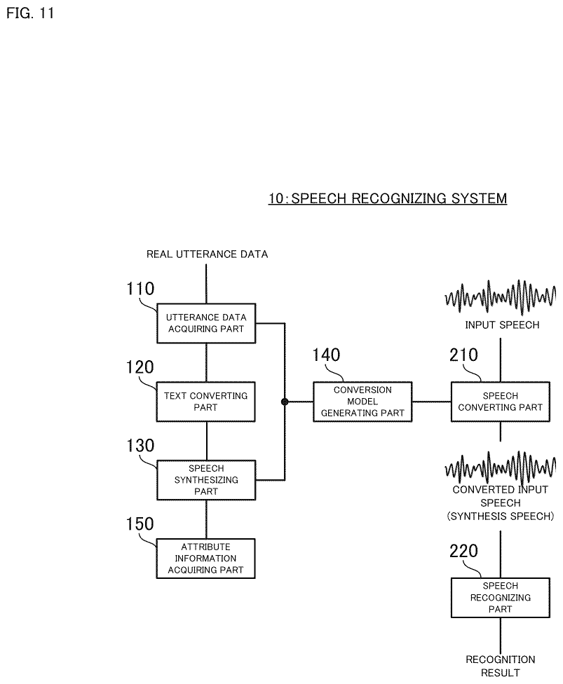

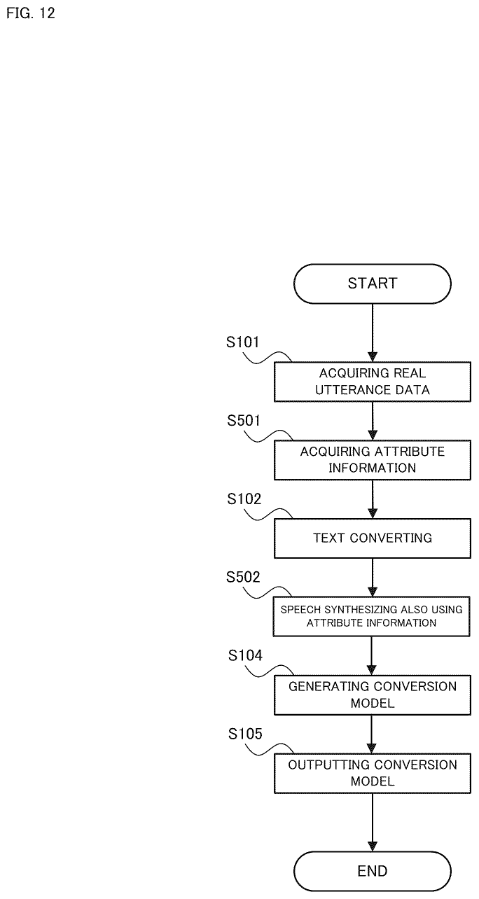

A speech recognizing system 10 of a fifth embodiment is described with referring to FIG. 11 and FIG. 12. Wherein, the fifth embodiment only differs a part of a configuration and a part of an operation from the above-mentioned first to fourth embodiments, and other parts may be the same as the first to fourth embodiments. Therefore, parts, that differ from each embodiment already described, are following described in detail, and description about other repetition parts is omitted as appropriate.

### (Functional Configuration)

First, a functional configuration of the speech recognizing system 10 of the fifth embodiment is described with referring to FIG. 11. FIG. 11 is a block diagram showing the functional configuration of the speech recognizing system of the fifth embodiment. Wherein, in FIG. 11, a component, which is similar to the component shown in FIG. 2, is given the same symbol.

As shown in FIG. 11, the speech recognizing system 10 of the fifth embodiment is configured to comprise an utterance data acquiring part 110, a text converting part 120, a speech synthesizing part 130, a conversion model generating part 140, an attribute acquiring part 150, a speech converting part 210 and a speech recognizing part 220 as components for realizing its functions. In other words, the speech recognizing system 10 of the fifth embodiment further comprises the attribute acquiring part 150 in addition to the configuration of the first embodiment (see FIG. 2). Wherein, the attribute acquiring part 150 may be a process block realized by the above-mentioned processor 11 (see FIG. 1), for example.

The attribute acquiring part 150 is configured to be able to acquire attribute information relating to a speaker of real utterance data. The attribute information may include information relating to such as gender, age and a job of the speaker. The attribute information acquiring part 150 may be configured to be able to acquire the attribute information from such as a terminal or an ID card held by the speaker. Alternatively, the attribute information acquiring part 150 may be configured to acquire the attribute information inputted by the speaker. It is configured that the attribute information acquired by the attribute information acquiring part 150 is outputted to the speech synthesizing part 130. The attribute information may be stored in real uttered speech corpus in a condition in which the attribute information is associated with real utterance data. In this case, it may be configured that the attribute information is outputted to the speech synthesizing part 130 from the real uttered speech corpus.

### (Conversion Model Generating Operation)

Next, flow of a conversion model generating operation by the speech recognizing system 10 of the fifth embodiment is described with referring to FIG. 12. FIG. 12 is a flowchart showing the flow of the conversion model generating operation by the speech recognizing system of the fifth embodiment. Wherein, in FIG. 12, a process, which is similar to the process shown in FIG. 3, is given the same symbol.

As shown in FIG. 12, when the conversion model generating operation is started by the speech recognizing system 10 of the fifth embodiment, first, the utterance data acquiring part 110 acquires real utterance data (step S101). Then, the attribute information acquiring part 150 acquires attribute information relating to a speaker of the real utterance data (step S501). Wherein, processes of steps S101 and S501 may be performed in any order, or may be performed in parallel at the same time.

Next, the text converting part 120 converts the real utterance data acquired by the utterance data acquiring part 110 into text data (step S102). After that, the speech synthesizing part 130 generates corresponding synthesis speech corresponding to the real utterance data by speech synthesizing the text data converted by the text converting part 120. In this embodiment, especially, the speech synthesizing part 130 performs speech synthesis also using the attribute information (step S502). For example, the speech synthesizing part 130 may perform speech synthesis considering such as gender, age and a job of the speaker of the real utterance data.

Next, the conversion model generating part 140 generates a conversion model on the basis of the real utterance data acquired by the utterance data acquiring part 110 and the corresponding synthesis speech (here, synthesis speech which is speech synthesized on the basis of the attribute information) generated by the speech synthesizing part 130 (step S104). Wherein, a pare of the real utterance data and the corresponding synthesis speech, that are inputted to the conversion model generating part 140, may be given the attribute information. In this case, the conversion model generating part 140 may generate a conversion model considering the attribute information. After that, the conversion model generating part 140 outputs the generated conversion model to the speech converting part 210 (step S105).

### (Technical Effect)

Next, technical effect obtained by the speech recognizing system 10 of the fifth embodiment is described.

As described with FIG. 11 and FIG. 12, in the speech recognizing system 10 of the fifth embodiment, corresponding synthesis speech is generated using attribute information of a speaker. In this way, since the corresponding synthesis speech is generated in a condition in which attribute of the speaker is considered, it is possible to generate a more suitable speech conversion model. Moreover, when a speech recognition model is generated using the corresponding synthesis speech as the above-mentioned third embodiment (see FIG. 7 and FIG. 8), it is possible to generate a more suitable speech recognition model by using the corresponding synthesis speech considering the attribute information.

### Sixth Embodiment

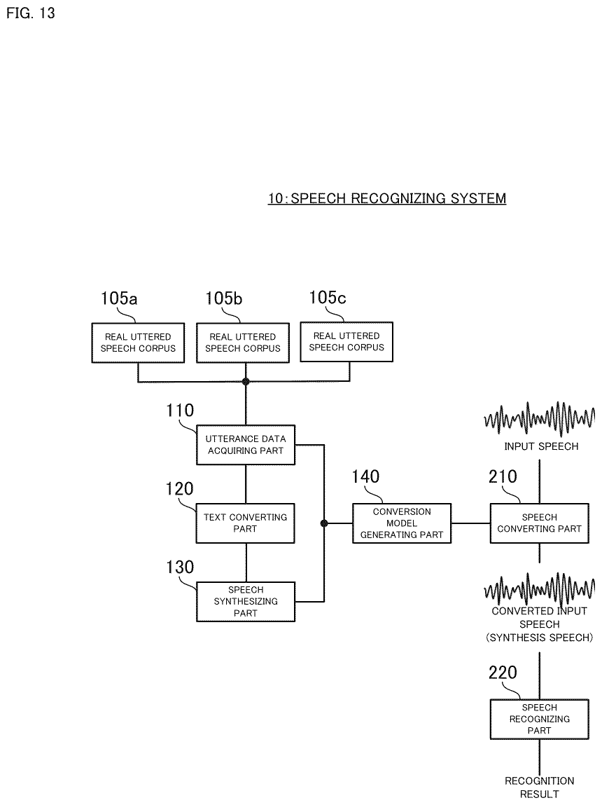

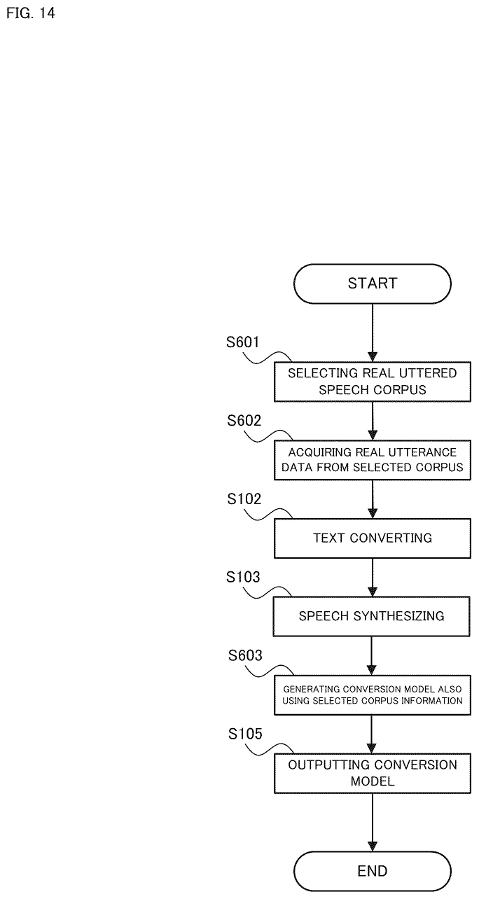

A speech recognizing system 10 of a sixth embodiment is described with referring to FIG. 13 and FIG. 14. Wherein, the sixth embodiment only differs a part of a configuration and a part of an operation from the above-mentioned first to fifth embodiments, and other parts may be the same as the first to fifth embodiments. Therefore, parts, that differ from each embodiment already described, are following described in detail, and description about other repetition parts is omitted as appropriate.

### (Functional Configuration)

First, a functional configuration of the speech recognizing system 10 of the sixth embodiment is described with referring to FIG. 13. FIG. 13 is a block diagram showing the functional configuration of the speech recognizing system of the sixth embodiment. Wherein, in FIG. 13, a component, which is similar to the component shown in FIG. 11, is given the same symbol.

As shown in FIG. 13, the speech recognizing system 10 of the sixth embodiment is configured to comprise a plurality of real uttered speech corpus 105a, 105b and 105c (hereinafter, collectively referring to as “real uttered speech corpus 105” as appropriate), an utterance data acquiring part 110, a text converting part 120, a speech synthesizing part 130, a conversion model generating part 140, a speech converting part 210 and a speech recognizing part 220 as components for realizing its functions. In other words, the speech recognizing system 10 of the sixth embodiment further comprises the plurality of real uttered speech corpus 105 in addition to the configuration of the first embodiment (see FIG. 2). Wherein, the plurality of real uttered speech corpus 105 may be configured by the above-mentioned storing device 14 (see FIG. 1), for example.

The plurality of real uttered speech corpus 105 store real utterance data for each predetermined condition. The “predetermined condition” here is a condition set for classifying real utterance data, for example. For example, each of the plurality of real uttered speech corpus 105 may be corpus storing real utterance data by category. In this case, the real uttered speech corpus 105a may be configured to store real utterance data relating to a law field, the real uttered speech corpus 105b may be configured to store real utterance data relating to a science field, and the real uttered speech corpus 105c may be configured to store real utterance data relating to a medical field. For convenience of explanation, three real uttered speech corpus 105 are shown, however, the number of real uttered speech corpus 105 is not limited.

The utterance data acquiring part 110 of the sixth embodiment is configured to acquire real utterance data by selecting one from the above-mentioned plurality of real uttered speech corpus 105. Wherein, information relating to the selected real uttered speech corpus 105 (specifically: information relating to a predetermined condition) may be outputted to the conversion model generating part 140 together with the real utterance data. Then, the conversion model generating part 140 may use the information relating to the selected real uttered speech corpus 105 in generating a conversion model. Moreover, in the configuration in which a speech recognition model is generated as the above-mentioned third embodiment, the information relating to the selected real uttered speech corpus 105 may be outputted to the speech recognition model generating part 310. Then, the speech recognition model generating part 310 may use the information relating to the selected real uttered speech corpus 105 in generating a speech recognition model.

### (Conversion Model Generating Operation)

Next, flow of a conversion model generating operation by the speech recognizing system 10 of the sixth embodiment is described with referring to FIG. 14. FIG. 14 is a flowchart showing the flow of the conversion model generating operation by the speech recognizing system of the sixth embodiment. Wherein, in FIG. 14, a process, which is similar to the process shown in FIG. 12, is given the same symbol.

As shown in FIG. 14, when the conversion model generating operation is started by the speech recognizing system 10 of the sixth embodiment, first, the utterance data acquiring part 110 selects corpus for acquiring utterance data from the plurality of real uttered speech corpus 105 (step S601). Then, the utterance data acquiring part 110 acquires real utterance data from the selected real uttered speech corpus (step S602).

Next, the text converting part 120 converts the real utterance data acquired by the utterance data acquiring part 110 into text data (step S102). Then, the speech synthesizing part 130 generates corresponding synthesis speech corresponding to the real utterance data by speech synthesizing the text data converted by the text converting part 120 (step S103).

Next, the conversion model generating part 140 generates a conversion model on the basis of the real utterance data acquired by the utterance data acquiring part 110 and the corresponding synthesis speech generated by the speech synthesizing part 130. In this embodiment, especially, the conversion model generating part 140 also uses the information relating to the selected real uttered speech corpus (step S606). After that, the conversion model generating part 140 outputs the generated conversion model to the speech converting part 210 (step S105).

### (Technical Effect)

Next, technical effect obtained by the speech recognizing system 10 of the sixth embodiment is described.

As described with FIG. 13 and FIG. 14, in the speech recognizing system 10 of the sixth embodiment, information relating to real uttered speech corpus 105, which is selected when real utterance data is acquired, is used in generating a conversion model. In this way, since a predetermined condition (e.g., field), which is used for classifying real utterance data, is considered, it is possible to generate a more suitable conversion model.

### Seventh Embodiment

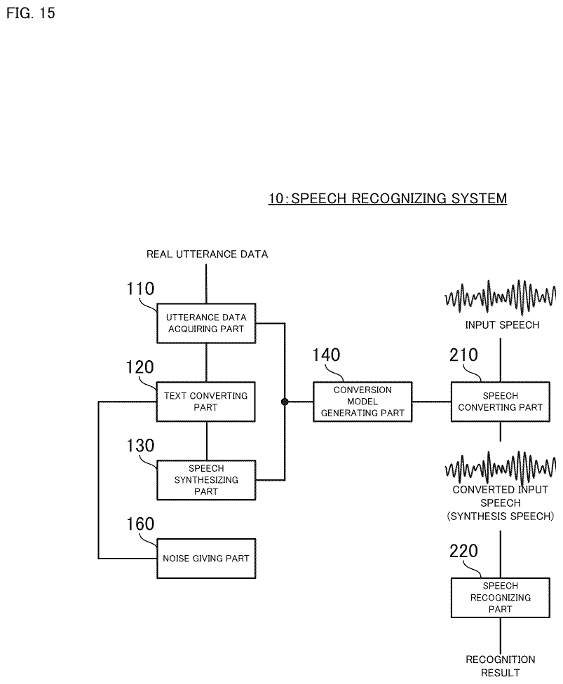

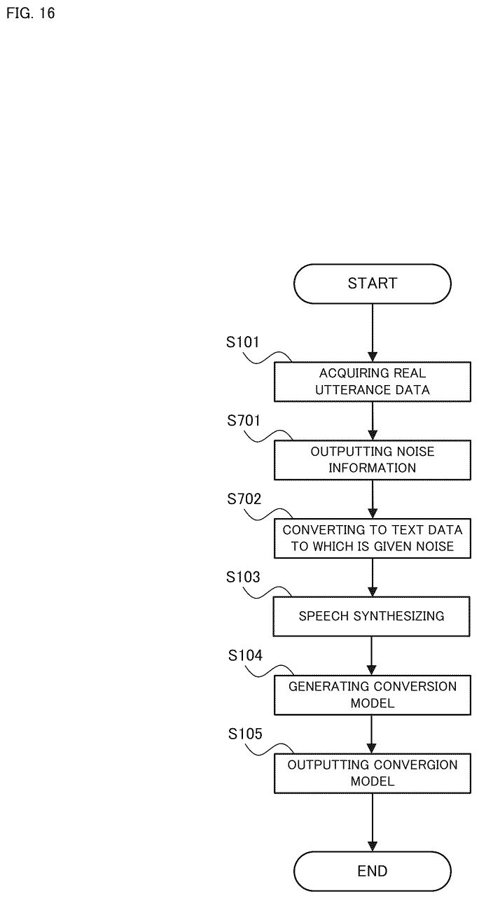

A speech recognizing system 10 of a seventh embodiment is described with referring to FIG. 15 and FIG. 16. Wherein, the seventh embodiment only differs a part of a configuration and a part of an operation from the above-mentioned first to sixth embodiments, and other parts may be the same as the first to sixth embodiments. Therefore, parts, that differ from each embodiment already described, are following described in detail, and description about other repetition parts is omitted as appropriate.

### (Functional Configuration)

First, a functional configuration of the speech recognizing system 10 of the seventh embodiment is described with referring to FIG. 15. FIG. 15 is a block diagram showing the functional configuration of the speech recognizing system of the seventh embodiment. Wherein, in FIG. 15, a component, which is similar to the component shown in FIG. 2, is given the same symbol.

As shown in FIG. 15, the speech recognizing system 10 of the seventh embodiment is configured to comprise an utterance data acquiring part 110, a text converting part 120, a speech synthesizing part 130, a conversion model generating part 140, a noise giving part 160, a speech converting part 210 and a speech recognizing part 220 as components for realizing its functions. In other words, the speech recognizing system 10 of the seventh embodiment further comprises the noise giving part 160 in addition to the configuration of the first embodiment (see FIG. 2). Wherein, the noise giving part 160 may be a process block realized by the above-mentioned processor 11 (see FIG. 1), for example.

The noise giving part 160 is configured to be able to give noise to text data generated by the text converting part 120. The noise giving part 160 may give noise to the text data by giving noise to real utterance data before text conversion, or may give noise to the text data after the text conversion. Alternatively, the noise giving part 160 may give noise when the text converting part 120 converts real utterance data into text data. The noise giving part 160 may give preset noise, or may give random set noise.

### (Conversion Model Generating Operation)

Next, flow of a conversion mode generating operation by the speech recognizing system 10 of the seventh embodiment is described with referring to FIG. 16. FIG. 16 is a flowchart showing the flow of the conversion model generating operation by the speech recognizing system of the seventh embodiment. Wherein, in FIG. 16, a process, which is similar to the process shown in FIG. 3, is given the same symbol.

As shown in FIG. 16, when the conversion model generating operation is started by the speech recognizing system 10 of the seventh embodiment, first, the utterance acquiring part 110 acquires real utterance data (step S101). In this embodiment, especially, the noise giving part 160 outputs noise to the text converting part 120 (step S701). Then, the text converting part 120 converts the real utterance data acquired by the utterance data acquiring part 110 into text data, to which is given noise (step S702).

Next, the speech synthesizing part 130 generates corresponding synthesis speech corresponding to the real utterance data by speech synthesizing the text data converted by the text converting part 120 (here, text data, to which is given noise) (step S103). Then, the conversion model generating part 140 generates a conversion model on the basis of the real utterance data acquired by the utterance data acquiring part 110 and the corresponding synthesis speech generated by the speech synthesizing part 130 (step S104). After that, the conversion model generating part 140 outputs the generated conversion model to the speech converting part 210 (step S105).

### (Technical Effect)

Next, technical effect obtained by the speech recognizing system 10 of the seventh embodiment is described.

As described with FIG. 15 and FIG. 16, in the speech recognizing system 10 of the seventh embodiment, real utterance data is converted into text data, to which is given noise. In this way, since a conversion model is generated using data including noise, it is possible to generate a conversion model which is tolerant of noise (e.g., a conversion model can speech convert even if input speech includes noise).

### <Modification of Seventh Embodiment>

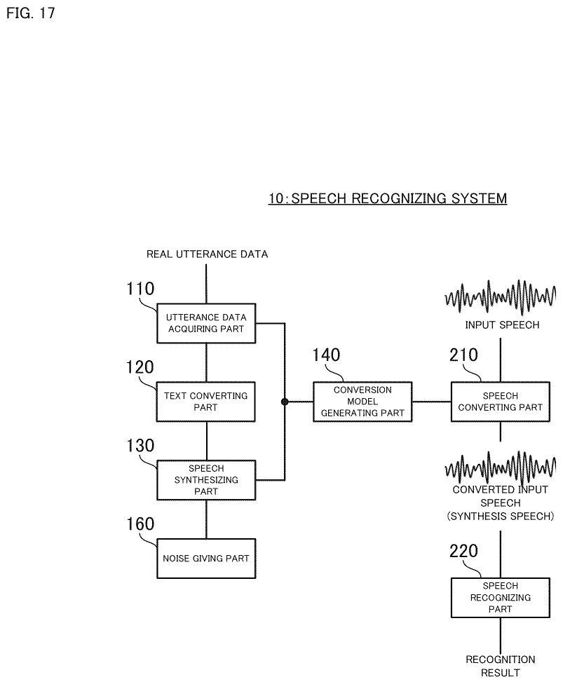

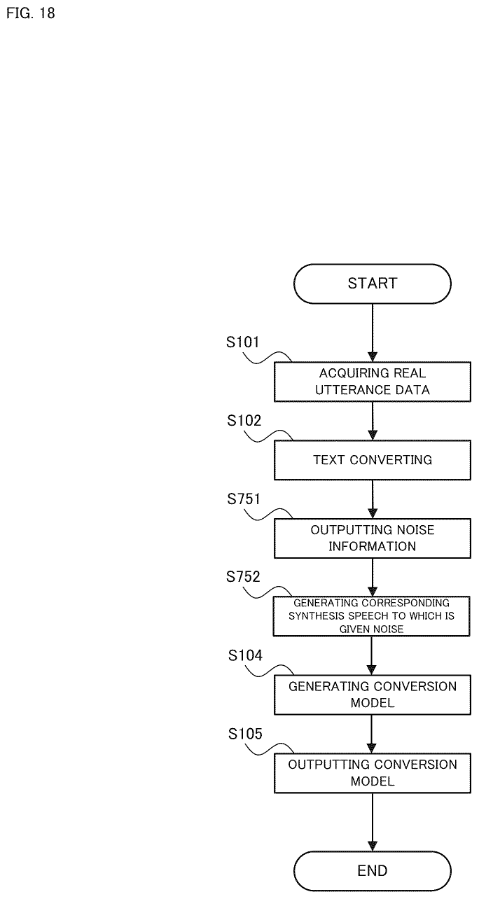

A speech recognizing system 10 of a modification of the seventh embodiment is described with referring to FIG. 17 and FIG. 18. Wherein, the modification of the seventh embodiment only differs a part of a configuration and a part of an operation from the above-mentioned seventh embodiment, and other parts may be the same as the first to seventh embodiments. Therefore, parts, that differ from each embodiment already described, are following described in detail, and description about other repetition part is omitted as appropriate.

### (Functional Configuration)

First, a functional configuration of the modification of the seventh embodiment is described with referring to FIG. 17. FIG. 17 is a block diagram showing the functional configuration of the modification of the seventh embodiment. Wherein, in FIG. 17, a component, which is similar to the component shown in FIG. 15, is given the same symbol.

As shown in FIG. 17, the speech recognizing system 10 of the modification of the seventh embodiment is configured to comprise an utterance data acquiring part 110, a text converting part 120, a speech synthesizing part 130, a conversion model generating part 140, a noise giving part 160, a speech converting part 210 and a speech recognizing part 220 as components for realizing its functions. However, in the speech recognizing system 10 of the modification of the seventh embodiment, the noise giving part 160 is configured to be able to output noise information to the speech synthesizing part 130. In other words, in the modification of the seventh embodiment, it is configured that noise is given at the time of speech synthesizing by the speech synthesizing part 130.

### (Conversion Model Generating Operation)

Next, flow of a conversion model generating operation by the speech recognizing system 10 of the modification of the seventh embodiment is described with referring to FIG. 18. FIG. 18 is a flowchart showing the flow of the conversion model generating operation by the speech recognizing system of the modification of the seventh embodiment. Wherein, in FIG. 8, a process, which is similar to the process shown in FIG. 16, is given the same symbol.

As shown in FIG. 18, when the conversion model generating operation is started by the speech recognizing system 10 of the modification of the seventh embodiment, first, the utterance data acquiring part 110 acquires real utterance data (step S101). Then, the text converting part 120 converts the real utterance data acquired by the utterance data acquiring part 110 into text data (step S102).

Next, in this embodiment, especially, the noise giving part 160 outputs noise information to the speech synthesizing part 130 (step S751). Then, the speech synthesizing part 130 generates corresponding synthesis speech, to which is given noise, by speech synthesizing the text data converted by the text data converting part 120 (step S752).

Next, the conversion model generating part 140 generates a conversion model on the basis of the real utterance data acquired by the utterance data acquiring part 110 and the corresponding synthesis speech generated by the speech synthesizing part 130 (here, corresponding synthesis speech, to which is given noise) (step S104). After that, the conversion model generating part 140 outputs the generated conversion model to the speech converting part 210 (step S105).

### (Technical Effect)

Next, technical effect obtained by the speech recognizing system 10 of the modification of the seventh embodiment is described.

As described with FIG. 17 and FIG. 18, in the speech recognizing system 10 of the modification of the seventh embodiment, corresponding synthesis speech, to which is given noise, is generated. In this way, since a conversion model is generated using data including noise, it is possible to generate a conversion model which is tolerant of noise (e.g., a conversion model can speech convert even if input speech includes noise).

### Eighth Embodiment

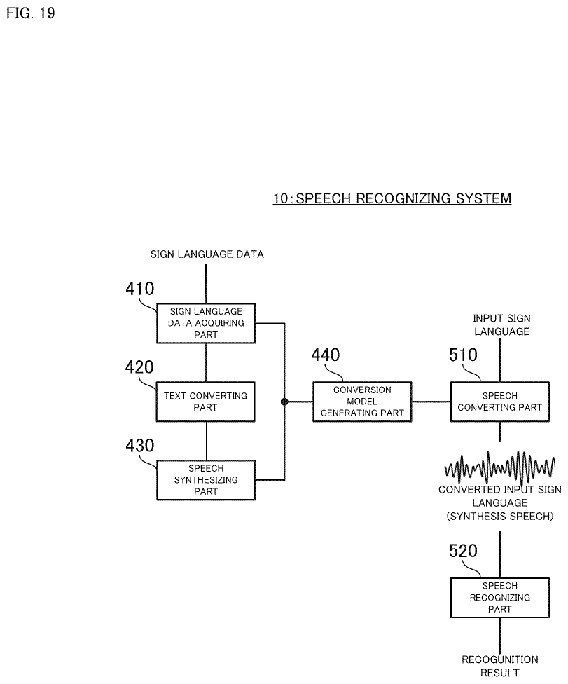

A speech recognizing system 10 of an eighth embodiment is described with referring to FIG. 19 to FIG. 21. Wherein, the eighth embodiment only differs a part of a configuration and a part of an operation from the above-mentioned first to seventh embodiments, and other parts may be the same as the first to seventh embodiment. Therefore, parts, that differ from each embodiment already described, are following described in detail, and description about other repetition part is omitted as appropriate.

### (Functional Configuration)

First, a functional configuration of the speech recognizing system 10 of the eighth embodiment is described with referring to FIG. 19. FIG. 19 is a block diagram showing the functional configuration of the speech recognizing system of the eighth embodiment.

As shown in FIG. 19, the speech recognizing system 10 of the eighth embodiment is configured to comprise a sign language data acquiring part 410, a text converting part 420, a speech synthesizing part 430, a conversion model generating part 440, a speech converting part 510 and a speech recognizing part 520 as components for realizing its functions. Each of the sign language data acquiring part 410, the text converting part 420, the speech synthesizing part 430, the conversion model generating part 440, the speech converting part 510 and the speech recognizing part 520 may be a process block realized by the above-mentioned processor 11 (see FIG. 1), for example.

The sign language data acquiring part 410 is configured to be able to acquire sign language data. Sign language data may be video data of sign language, for example. Sign language data may be acquired from a database accumulating a plurality of sign language data (i.e., sign language corpus), for example. It is configured that the sign language data acquired by the sign language data acquiring part 410 is outputted to the text converting part 420 and the conversion model generating part 440.

The text converting part 420 is configured to be able to convert the sign language data acquired by the sign language acquiring part 410 into text data. In other words, the text converting part 420 is configured to be able to perform a process for text converting things indicated by sign language included in the sign language data. Wherein, existing techniques may be suitably used as specific techniques of text converting. It is configured that the text data converted by the text converting part 420 (i.e., text data relating to the sign language data) is outputted to the speech synthesizing part 430.

The speech synthesizing part 430 is configured to be able to generate corresponding synthesis speech corresponding to the sign language data by speech synthesizing the text data converted by the text converting part 420. Wherein, existing techniques may be suitably used as specific techniques of speech synthesizing. It is configured that the corresponding synthesis speech generated by the speech synthesizing part 430 is outputted to the conversion model generating part 440. Alternatively; the corresponding synthesis speech may be accumulated in a database which can accumulate a plurality of corresponding synthesis speech (i.e., synthesis speech corpus), and then the corresponding synthesis speech may be outputted to the conversion model generating part 440.

The conversion model generating part 440 is configured to be able to generate a conversion model which converts input sign language into synthesis speech using the sign language data acquired by the sign language acquiring part 410 and the corresponding synthesis speech synthesized by the speech synthesizing part 430. The conversion model converts inputted input sign language (e.g., video data of sign language) into synthesis speech (i.e., mechanical voice), for example. The conversion model generating part 440 may be configured to generate a conversion model using a GAN, for example. It is configured that the conversion model generated by the conversion model generating part 440 is outputted to the speech converting part 510.

The speech converting part 510 is configured to be able to convert input sign language into synthesis speech using the conversion model generated by the conversion model generating part 440. The input sign language inputted to the speech converting part 510 may be video inputted by using such as a camera. It is configured that the synthesis speech converted by the speech converting part 510 is outputted to the speech recognizing part 520.

The speech recognizing part 520 is configured to be able to speech recognize the synthesis speech converted by the speech converting part 510. In other words, the speech recognizing part 520 is configured to be able to perform a process for converting the synthesis speech into text. The speech recognizing part 520 may be configured to output a speech recognition result of the synthesis speech. Wherein, there are no particular limitations on how to use the speech recognition result.

### (Conversion Model Generating Operation)

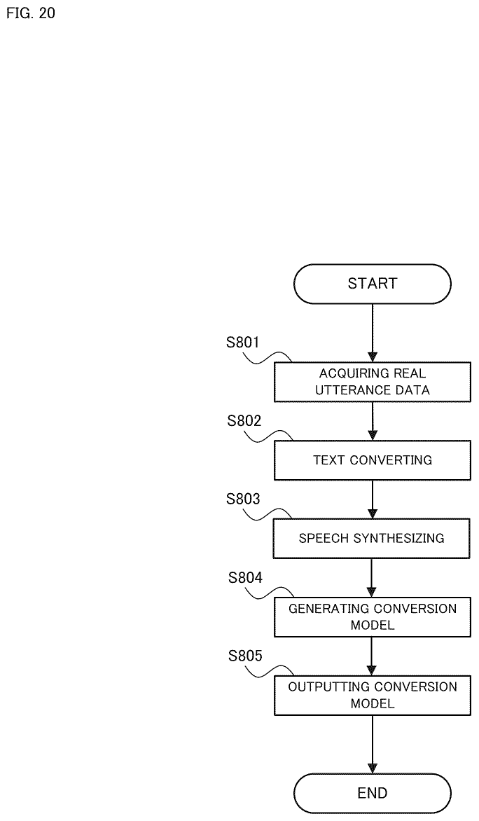

Next, flow of a conversion model generating operation by the speech recognizing system 10 of the eighth embodiment is described with referring to FIG. 20. FIG. 20 is a flowchart showing the flow of the conversion model generating operation by the speech recognizing system of the eighth embodiment.

As shown in FIG. 20, when the conversion model generating operation is started by the speech recognizing system 10 of the eighth embodiment, first, the sign language acquiring part 410 acquires sign language data (step S801). Then, the text converting part 420 converts the sign language data acquired by the sign language acquiring part 410 into text data (step S802).

Next, the speech synthesizing part 430 generates corresponding synthesis speech corresponding to the sign language data by speech synthesizing the text data converted by the text data converting part 420 (step S803). Then, the conversion model generating part 440 generates a conversion model on the basis of the sign language data acquired by the sign language acquiring part 410 and the corresponding synthesis speech generated by the speech synthesizing part 430 (step S804). After that, the conversion model generating part 440 outputs the generated conversion model to the speech converting part 510 (step S805).

### (Speech Recognizing Operation)

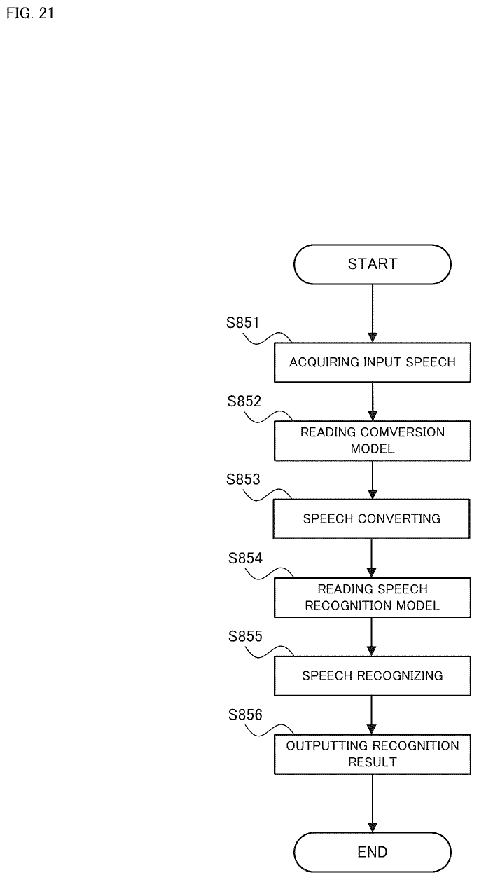

Next, flow of a speech recognizing operation by the speech recognizing system 10 of the eighth embodiment is described with referring to FIG. 21. FIG. 21 is a flowchart showing the flow of the speech recognizing operation by the speech recognizing system of the eighth embodiment.

As shown in FIG. 21, when the speech recognizing operation is started by the speech recognizing system 10 of the eighth embodiment, first, the speech converting part 510 acquires input sign language (step S851). Then, the speech converting part 510 reads the conversion model generated by the conversion model generating part 440 (step S852). After that, the speech converting part 510 converts the input sign language into synthesis speech by speech converting using the read conversion model (step S853).

Next, the speech recognizing part 520 reads a speech recognition model (step S854). Then, the speech recognizing part 520 speech recognizes the synthesis speech synthesized by the speech converting part 510 using the read speech recognition model (step S855). After that, the speech recognizing part 520 outputs a speech recognition result (step S856).

### (Technical Effect)

Next, technical effect obtained by the speech recognizing system 10 of the eighth embodiment is described.

As described with FIG. 19 to FIG. 21, in the speech recognizing system 10 of the eighth embodiment, sign language data and corresponding synthesis speech corresponding to the sign language data are used when a conversion model is generated. Especially, the corresponding synthesis speech corresponding to the sign language data is generated by converting the sign language data into text, and speech synthesizing text data. In this way, it is not necessary to prepare both of sign language data and synthesis speech corresponding to it (i.e., it is possible to generate corresponding synthesis speech if only sign language data is prepared) so that it is possible to reduce cost for generating a conversion model. As a result, it is possible to realize speech recognition with low cost and high recognition accuracy.

A processing method recording a program, which make the configuration of each embodiment as above operate such that functions of each embodiment is realized, in a recording medium, reading the program recorded in the recording medium as cords, performing at a computer is included in scope of each embodiment. Moreover, the recording medium, in which the above-mentioned program is recorded, as well as the program itself are included in each embodiment.

As the recording medium, a floppy disk, a hard disk, an optical disk, an optical magnetic disk, a CD-ROM, a magnetic tape, a nonvolatile memory card and a ROM may be used, for example. Moreover, the scope of each embodiment includes not only performing processes by only the program recorded the recording medium but also performing processes by operating on an OS together with other softwares and/or functions of extension boards. Furthermore, it may be configured that the program itself is stored in a server, and a part of or all of the program can be downloaded from the server to a user terminal.

### <Supplementary Note>

In regard to embodiments described above, the following supplementary notes may be further described, but are not limited to the following.

### (Supplementary Note 1)

A speech recognizing system described in a supplementary note 1 is a speech recognizing system comprising: an utterance data acquiring means for acquiring real utterance data uttered by a speaker, a text converting means for converting the real utterance data into text data, a speech synthesizing means for generating corresponding synthesis speech corresponding to the real utterance data by speech synthesizing using the text data, a conversion model generating means for generating a conversion model converting input speech into synthesis speech using the real utterance data and the corresponding synthesis speech, and a speech recognizing means for speech recognizing the synthesis speech converted using the conversion model.

### (Supplementary Note 2)

A speech recognizing system described in a supplementary note 2 is the speech recognizing system according to the supplementary note 1, wherein the conversion model generating means adjusts parameters of the conversion model using the input speech and a recognition result of the speech recognizing means.

### (Supplementary Note 3)

A speech recognizing system described in a supplementary note 3 is the speech recognizing system according to the supplementary note 1 or 2 further comprising a speech recognition model generating means for generating a speech recognition model using data including the corresponding synthesis speech, wherein the speech recognizing means speech recognizes using the speech recognition model.

### (Supplementary Note 4)

A speech recognizing system described in a supplementary note 4 is the speech recognizing system according to the supplementary note 3, wherein the speech recognition model generating means adjusts parameters of the speech recognition model using the synthesis speech converted using the conversion model and a recognition result of the speech recognizing means.

### (Supplementary Note 5)

A speech recognizing system described in a supplementary note 5 is the speech recognizing system according to any one of supplementary notes 1 to 4 further comprising an attribute acquiring means for acquiring attribute information indicating attribute of the speaker, wherein the speech synthesizing means generates the corresponding synthesis speech by speech synthesizing using the attribute information.

### (Supplementary Note 6)

A speech recognizing system described in a supplementary note 5 is the speech recognizing system according to any one of supplementary notes 1 to 5 further comprising a plurality of real uttered speech corpus storing the real utterance data for each predetermined condition, wherein the utterance data acquiring means acquires the real utterance data by selecting one from the plurality of real uttered speech corpus.

(Supplementary Note 7)

A speech recognizing system described in a supplementary note 7 is the speech recognizing system according to any one of supplementary notes 1 to 6 further comprising a noise giving means for giving noise to at least one of the text data and the corresponding synthesis speech.

### (Supplementary Note 8)

A speech recognizing system described in a supplementary note 8 is a speech recognizing system comprising: a sign language acquiring means for acquiring sign data, a text converting means for converting the sign language data into text data, a speech synthesizing means for generating corresponding synthesis speech corresponding to the sign language data by speech synthesizing using the text data, a conversion model generating means for generating a conversion model converting inputted sign language into synthesis speech using the sign language data and the corresponding synthesis speech, and a speech recognizing means for speech recognizing the synthesis speech converted using the conversion model.

### (Supplementary Note 9))

A speech recognizing method described in a supplementary note 9 is a speech recognizing method in which at least one computer acquires real utterance data uttered by a speaker, converts the real utterance data into text data, generates corresponding synthesis speech corresponding to the real utterance data by speech synthesizing using the text data, generates a conversion model converting input speech into synthesis speech using the real utterance data and the corresponding synthesis speech, and speech recognizes the synthesis speech converted using the conversion model.

### (Supplementary Note 10)

A recording medium described in a supplementary note 10 is a recording medium in which a computer program is recorded, wherein the computer program making at least one computer perform a speech recognizing method acquiring real utterance data uttered by a speaker, converting the real utterance data into text data, generating corresponding synthesis speech corresponding to the real utterance data by speech synthesizing using the text data, generating a conversion model converting input speech into synthesis speech using the real utterance data and the corresponding synthesis speech and speech recognizing the synthesis speech converted using the conversion model.

### (Supplementary Note 11)

A computer program described in a supplementary note 11 is a computer program making at least one computer perform a speech recognizing method acquiring real utterance data uttered by a speaker, converting the real utterance data into text data, generating corresponding synthesis speech corresponding to the real utterance data by speech synthesizing using the text data, generating a conversion model converting input speech into synthesis speech using the real utterance data and the corresponding synthesis speech and speech recognizing the synthesis speech converted using the conversion model.

### (Supplementary Note 12)

A speech recognizing apparatus described in a supplementary note 12 is a speech recognizing apparatus comprising: an utterance data acquiring means for acquiring real utterance data uttered by a speaker, a text converting means for converting the real utterance data into text data, a speech synthesizing means for generating corresponding synthesis speech corresponding to the real utterance data by speech synthesizing using the text data, a conversion model generating means for generating a conversion model converting input speech into synthesis speech using the real utterance data and the corresponding synthesis speech, and a speech recognizing means for speech recognizing the synthesis speech converted using the conversion model.

### (Supplementary Note 13)

A speech recognizing method described in a supplementary note 13 is a speech recognizing method in which at least one computer acquires sign data, converts the sign language data into text data, generates corresponding synthesis speech corresponding to the sign language data by speech synthesizing using the text data, generates a conversion model converting inputted sign language into synthesis speech using the sign language data and the corresponding synthesis speech, and speech recognizes the synthesis speech converted using the conversion model.

### (Supplementary Note 14)

A recoding medium described in a supplementary note 14 is a recording medium in which a computer program is recorded, wherein the computer program making at least one computer perform a speech recognizing method acquiring sign data, converting the sign language data into text data, generating corresponding synthesis speech corresponding to the sign language data by speech synthesizing using the text data, generating a conversion model converting inputted sign language into synthesis speech using the sign language data and the corresponding synthesis speech, and speech recognizing the synthesis speech converted using the conversion model.

### (Supplementary Note 15)

A computer program described in a supplementary note 15 is a computer program making at least one computer perform a speech recognizing method acquiring sign data, converting the sign language data into text data, generating corresponding synthesis speech corresponding to the sign language data by speech synthesizing using the text data, generating a conversion model converting inputted sign language into synthesis speech using the sign language data and the corresponding synthesis speech, and speech recognizing the synthesis speech converted using the conversion model.

### (Supplementary Note 16)

A speech recognizing apparatus described in a supplementary note 16 is a speech recognizing apparatus comprising: a sign language acquiring means for acquiring sign data, a text converting means for converting the sign language data into text data, a speech synthesizing means for generating corresponding synthesis speech corresponding to the sign language data by speech synthesizing using the text data, a conversion model generating means for generating a conversion model converting inputted sign language into synthesis speech using the sign language data and the corresponding synthesis speech, and a speech recognizing means for speech recognizing the synthesis speech converted using the conversion model.

This disclosure can appropriately be changed within limits being not contrary to summary of inventions or ideas, that can be read from the scope of claims and all of the specification, a speech recognizing system, a speech recognizing method and a recoding medium with such changes are also included in technical ideas of this disclosure.

### EXPLANATION OF REFERENCE CODES

10 Speech recognizing system
11 Processor
14 Storing device
105 Real uttered speech corpus
110 Utterance data acquiring part
120 Text converting part
130 Speech synthesizing part
140 Conversion model generating part
150 Attribute information acquiring part
160 Noise giving part
210 Speech converting part
220 Speech recognizing part
310 Speech recognition model generating part
410 Sign language data acquiring part
420 Text converting part
430 Speech synthesizing part
440 Conversion model generating part
510 Speech converting part
520 Speech recognizing part

What is claimed is:

1. A speech recognizing system comprising:
at least one memory that is configured to store instructions; and
at least one processor that is configured to execute the instructions to:
acquire real utterance data uttered by a speaker;
convert the real utterance data into text data;
generate corresponding synthesis speech corresponding to the real utterance data by speech synthesizing using the text data;
generate a conversion model converting input speech into synthesis speech using the real utterance data and the corresponding synthesis speech; and
speech recognize the synthesis speech converted using the conversion model.

2. The speech recognizing system according to claim 1, wherein the at least one processor is configured to execute the instructions to
adjust parameters of the conversion model using the input speech and a recognition result of the speech recognizing.

3. The speech recognizing system according to claim 1, wherein the at least one processor is configured to execute the instructions to:
generate a speech recognition model using data including the corresponding synthesis speech, and
speech recognize using the speech recognition model.

4. The speech recognizing system according to claim 3, wherein the at least one processor is configured to execute the instructions to
adjust parameters of the speech recognition model using the synthesis speech converted by using the conversion model and a recognition result of the speech recognizing.

5. The speech recognizing system according to claim 1, wherein the at least one processor is configured to execute the instructions to:
acquire attribute information indicating attribute of the speaker, and
generate the corresponding synthesis speech by performing speech synthesizing using the attribute information.

6. The speech recognizing system according to claim 1,
further comprising a plurality of real uttered speech corpus storing the real utterance data for each predetermined condition,
wherein the at least one processor is configured to execute the instructions to acquire the real utterance data by selecting one from the plurality of real uttered speech corpus.

7. The speech recognizing system according to claim 1, wherein the at least one processor is configured to execute the instructions to:
give noise at least one of the text data and the corresponding synthesis speech.

8. A speech recognizing system comprising:
at least one memory that is configured to store instructions; and
at least one processor that is configured to execute the instructions to:
acquire sign language data;
convert the sign language data into text data;
generate corresponding synthesis speech corresponding to the sign language data by speech synthesizing using the text data;
generate a conversion model converting input sign language into synthesis speech using the sign language data and the corresponding synthesis speech; and
speech recognize the synthesis speech converted using the conversion model.

9. A speech recognizing method in which at least one computer
acquires real utterance data uttered by a speaker,
converts the real utterance data into text data,
generates corresponding synthesis speech corresponding to the real utterance data by speech synthesizing using the text data,
generates a conversion model converting input speech into synthesis speech using the real utterance data and the corresponding synthesis speech, and
speech recognizes the synthesis speech converted using the conversion model.

10. (canceled)
